(19) United States
(12) Patent Application Publication
(10) Pub. No.: US 2025/0157134 A1
(43) Pub. Date: May 15, 2025

(54) Adjusting Virtual View in a Mirrored Virtual World

(71) Applicant: Niantic, Inc., San Francisco, CA (US)

(72) Inventor: Ben Benfold, Oxford (GB)

(21) Appl. No.: 18/942,346

(22) Filed: Nov. 8, 2024

Related U.S. Application Data
(60) Provisional application No. 63/598,043, filed on Nov. 10, 2023.

(51) Int. Cl. G06T 15/20; A63F 13/5378; G06T 7/73; G06T 17/05; G06T 17/20; G06T 19/00

(52) U.S. Cl. CPC G06T 15/20; A63F 13/5378; G06T 7/75; G06T 17/05; G06T 17/20; G06T 19/006; G06T 2207/30244

(57) ABSTRACT

A method, system, and computer-readable storage medium are disclosed for displaying virtual elements (e.g., AR content) in a physical environment by a client device using a virtual camera pose that is different from the pose of the physical camera used to capture images of the physical environment. The client device uses a three-dimensional (3D) map (e.g., a topographical mesh) of the physical environment to determine a pose (a position and orientation) of the camera of the client device. The 3D map can include geometry, colors, textures, or any other suitable information describing the physical environment.

### TECHNICAL FIELD

The present disclosure relates generally to mirrored virtual worlds, and, in particular, to translating a camera pose from a default pose to a custom pose.

### BACKGROUND

In conventional parallel-reality game systems, client devices display views of a virtual world from the point-of-view of a physical camera of the client device. The virtual world may be displayed as virtual elements, such as augmented reality (AR) content, overlaid on images of the real world captured by the camera of the client device. Over extended periods of time, this can be frustrating and physically inconvenient for users, who must point their device's camera at particular locations to view the virtual elements.

### SUMMARY

A method, system, and computer-readable storage medium are disclosed for displaying virtual elements (e.g., AR content) in a physical environment by a client device using a virtual camera pose that is different from the pose of the physical camera used to capture images of the physical environment. The client device uses a three-dimensional (3D) map (e.g., a topographical mesh) of the physical environment to determine a pose (a position and orientation) of the camera of the client device. The 3D map can include geometry, colors, textures, or any other suitable information describing the physical environment.

The 3D map may be generated by the client device (or by a server that receives information describing the physical environment from the client device) or the client device may retrieve a previously generated 3D map for the physical environment from local storage or a server. For example, the client device may provide GPS coordinate to the server that provides a pre-generated 3D map corresponding to those GPS coordinates to the client device in response. The client device may then use the received 3D map to determine the pose of the client device within the environment. In some instances, the client device may update or extend the 3D map as the user moves around the physical environment.

Using the 3D map, the client device creates a view of the physical environment (and any corresponding AR content) from a pose different from but related to the pose of the physical camera. For example, a user may hold their device at a comfortable angle with the camera pointing at the ground in front of them (e.g., at a 45 or 60 degree angle to the ground) and the screen of the user's client device may display a view of the environment (and any AR content) as if the user was pointing the camera straight ahead (e.g., parallel to the ground).

### BRIEF DESCRIPTION OF THE DRAWINGS

FIG. 1 is a block diagram illustrating a computing environment suitable for providing custom pose views of a virtual world, according to one embodiment.

FIG. 2 is a block diagram of a client device shown in FIG. 1, according to one embodiment.

FIG. 3 is a block diagram of the server shown in FIG. 1, according to one embodiment.

FIG. 4A illustrates a situation where the virtual pose is the same as the physical pose.

FIG. 4B illustrates a situation where the virtual pose is different from the virtual pose by an angular offset, according to one embodiment.

FIG. 5A illustrates a physical environment including physical objects captured by a physical camera, according to one embodiment.

FIG. 5B illustrates a view of the environment using the physical pose of the camera, according to one embodiment.

FIG. 5C illustrates a virtual pose that has an angular and positional offset relative to the physical pose of the camera, according to one embodiment.

FIG. 5D illustrates a view of the environment using the virtual pose of FIG. 5C, according to one embodiment.

FIG. 5E illustrates AR content within the environment depicted in FIG. 5C, according to one embodiment.

FIG. 5F illustrates a view of the environment including AR content using the virtual pose of FIG. 5C, according to one embodiment.

FIG. 6 is a flowchart illustrating a method for providing virtual content on a client device from a custom viewpoint, according to one embodiment.

FIG. 7 is a block diagram illustrating an example computer suitable for use in the computing environment of FIG. 1, according to one embodiment.

### DETAILED DESCRIPTION

Reference will now be made to several embodiments, examples of which are illustrated in the accompanying figures. It is noted that wherever practicable similar or like reference numbers are used in the figures to indicate similar or like functionality. Also, where similar elements are identified by a reference number followed by a letter, a reference to the number alone in the description that follows may refer to all such elements, any one such element, or any combination of such elements. One skilled in the art will readily recognize from the following description that alternative embodiments of the structures and methods may be employed without departing from the principles described.

### Exemplary Location-Based Parallel Reality Gaming System

Various embodiments are described in which AR content is displayed from a custom viewpoint in the context of a parallel reality game. A parallel reality game is a location-based game having a virtual world geography that parallels at least a portion of the real-world geography such that player movement and actions in the real-world affect actions in the virtual world. In particular, a parallel reality game can include interactive display of both the real-world (e.g., images of the real world or a 3D model of the real world) and the virtual world (e.g., virtual objects), such as AR content. However, the subject matter of the present disclosure may be equally applicable to other location-based applications or applications that otherwise provide AR content.

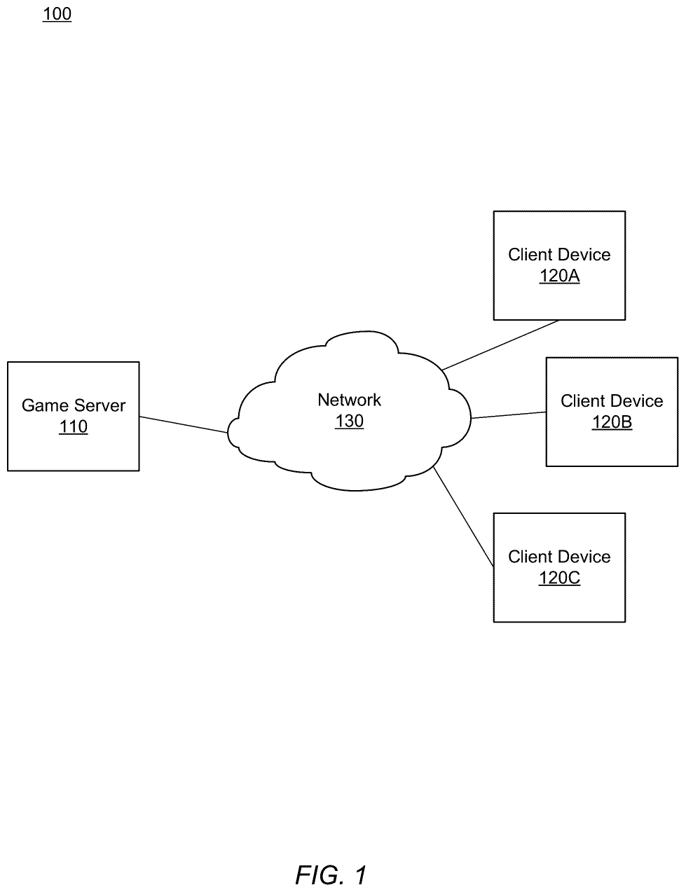

FIG. 1 is a block diagram illustrating one embodiment of a computing environment for a location-based gaming system 100. In the embodiment shown, the location-based gaming system 100 provides for the interaction of a plurality of players in a virtual world having a geography that parallels the real world. In particular, a geographic area in the real world can be linked or mapped directly to a corresponding area in the virtual world. A player can move about in the virtual world by moving to various geographic locations in the real world. For instance, the system 100 can track a player's position in the real world and update the player's position in the virtual world based on the player's current position in the real world. For example, a coordinate system in the real world (e.g., longitude and latitude) may be mapped to a coordinate system in the virtual world (e.g., x/y coordinates, virtual longitude and latitude, etc.).

In the embodiment shown in FIG. 1, the system 100 has a client-server architecture, where a server 110 communicates with one or more client devices 120 over a network 130. Although three client devices 120 are illustrated in FIG. 1, any number of client devices 120 can be connected to the server 110 over the network 130. Similarly, the system 100 may include multiple servers 110 to provide load balancing and increase the number of client devices 120 that may be served. In other embodiments, the distributed location-based gaming system 100 includes different or additional elements. Furthermore, the functions may be distributed among the elements in a different manner than described.

The server 110 hosts a universal state of the location-based game and provides game status updates to players' client devices 120 (e.g., based on actions taken by other players in the game, changes in real-world conditions, changes in game state or condition, etc.). The server 110 receives and processes input from players in the location-based game. Players may be identified by a username or player ID (e.g., a unique number or alphanumeric string) that the players' client devices 120 send to the server 110 in conjunction with the players' inputs. In some embodiments, the server hosts several location-based games, other types of games, or other applications.

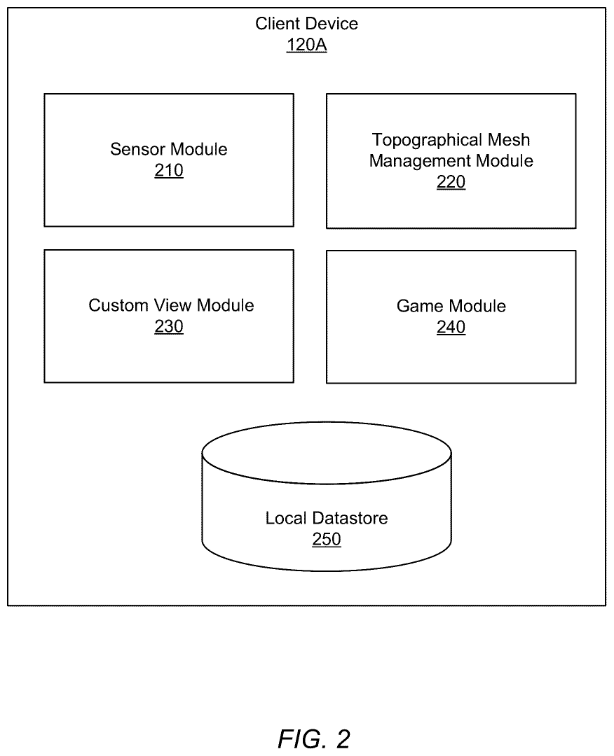

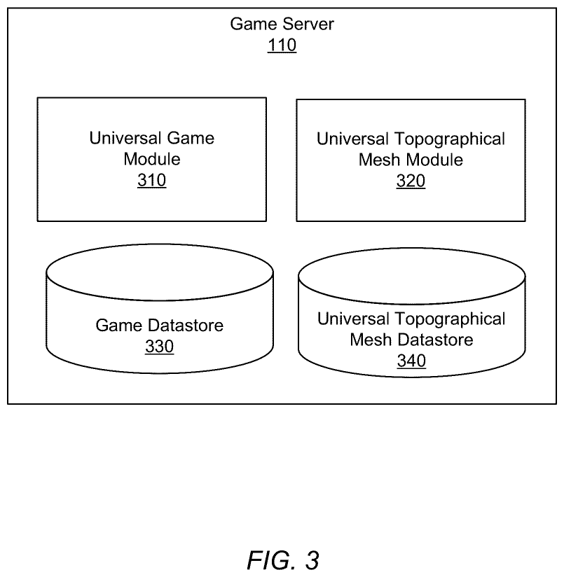

In various embodiments, the server 110 communicates with the client devices 120 to provide AR content from a custom viewpoint on the client devices 120. The server 110 can provide virtual content or images of the real world to the client devices 120 for display or other processing. In particular, the server 110 can provide 3D maps (e.g., topographical meshes, Gaussian splats, or 3D voxels, etc.) representing real-world environments to enable display by the client device of views of the environments from camera poses other than the physical camera pose of the client device, as described in greater detail below with reference to FIGS. 2-5F. The 3D maps provided by the server 110 to the client systems 120 may be previously received from the same or different client devices 120, generated at the server 110 using information received from the client devices 120 or other devices, or otherwise obtained by the server 110. Various embodiments of the server 110 are described in greater detail below with reference to FIG. 3.

The client devices 120 are computing devices with which players can interact with the server 110. For instance, a client device 120 can be a smartphone, portable gaming device, tablet, personal digital assistant (PDA), cellular phone, navigation system, handheld GPS system, or other such device. Although three client devices are depicted in FIG. 1 (i.e., client device 120A, 120B, and 120C), the location-based gaming system 100 may include any number of client devices 120. A client device 120 executes software associated with the location-based game hosted by the server 110, such as a client game application, to allow a player to interact with the virtual world. The client devices 120 are additionally configured to display AR content, such as for the location-based game hosted by the server 110.

The client devices 120 display AR content using images of the real-world captured by a camera, such as a camera integrated with the client devices 120 (e.g., a camera of a cellular phone). The client devices 120 further obtain 3D maps representing physical geometry and appearance of a real-world environment to display AR content from a different viewpoint than the camera used to capture the images of the real-world environment (i.e., a custom viewpoint). The 3D maps are three-dimensional representations of an environment within the real-world and can include combinations of geometry (e.g., a polygon mesh), colors (e.g., RGB data), textures (e.g., texture maps, bump maps, etc.), other material properties (e.g., reflectance, friction, density, etc.), or other information describing the real-world environment.

Depending on the embodiment, 3D maps may be generated (e.g., by the client systems 120 or server 110) using processes requiring varying degrees of computational complexity and respectively producing 3D maps which can be displayed with varying degrees of visual accuracy (e.g., resemblance to the real-world environment). In particular, the geometry of a topographical mesh can be represented using a high-density polygon mesh (e.g., high polygon count) which achieve at or near a one-to-one correspondence with the real-world environment. Furthermore, the 3D maps used by the client devices 120 can include photo-realistic or near photo-realistic geometry and textures representing the real-world environment. Embodiments for efficiently generating topographical mesh-based 3D maps which can be displayed with high visual accuracy are described in greater detail below with reference to the topographical mesh management module 220. To display a custom view, instead of displaying images of the real-world environment overlaid with virtual objects, the client devices 120 can display a 3D map representing the real-world environment from any custom viewpoint (e.g., from a camera pose positioned in the same location as the physical camera of the client device but at a different angle to enable the player to hold the client device in a comfortable position). The client device may also display one or more virtual elements (e.g., AR objects) in conjunction with the view of the real-world environment from the custom viewpoint. Various embodiments of the client devices 120, including embodiments of displaying AR content from custom viewpoints, are described in greater detail below, with reference to FIG. 2.

The network 130 can be any type of communications network, such as a local area network (e.g., intranet), wide area network (e.g., internet), or some combination thereof. The network can also include a direct connection between a client 120 and the server 110. In general, communication between the server 110 and a client 120 can be carried via a network interface using any type of wired and/or wireless connection, using a variety of communication protocols (e.g., TCP/IP, HTTP, S1v1TP, FTP), encodings or formats (e.g., HTML, JSON, XML), and/or protection schemes (e.g., VPN, secure HTTP, SSL).

FIG. 2 is block diagram of one embodiment of the client device 120A shown in FIG. 1. The client device 120A is associated with a player of the parallel-reality game. Other client devices (e.g., client devices 120B and 120C) have the same or similar architectures and are associated with other players of the parallel-reality game. Because the gaming system 100 is for a location-based game, the client devices 120 are preferably portable computing devices, such as smartphones or other portable devices, that can be easily carried or otherwise transported with a player. A player can interact with the virtual world simply by carrying or transporting their client device 120 in the actual world. In the embodiment shown, the client device 120A includes a sensor module 210, topographical mesh management module 220, a custom view module 230, a game module 240, and a local datastore 250. In other embodiments, the client device 120A includes additional or different components than those depicted in FIG. 2.

The sensor module 210 manages one or more sensor components of the client device 120A used to scan a real-world environment around the client device 120A. Sensors managed by the sensor module 210 can be used to collect various information describing the real-world environment around the client device 120A (i.e., scanning information), such as images, depth information, audio recordings, light levels, air pressure readings, etc. In some embodiments, the sensors managed by the sensor module 210 include one or more cameras that capture images of the real-world environment. In the same or different embodiments, the sensors managed by the sensor module 210 can include three-dimensional scanning devices, such as laser scanners (e.g., Light Detection and Ranging (e.g., LIDAR) devices), structured light scanners, or modulated light scanners. The client device 120A can perform a scan of the real-world environment to collect the scanning information, such as using one or more cameras or other sensors managed by the sensor module 210. The sensor module 210 may communicate with other components of the client device 120A to perform a scan of the real-world environment, as described below.

The topographical mesh management module 220 manages topographical meshes for the client device 120A. Although embodiments are described that use topographical meshes, it should be appreciated that other types of 3D map may be used. In embodiments, the topographical mesh management module 220 uses scanning information describing a real-world environment around client device 120A (e.g., provided by the sensor module 210) to generate a topographical mesh or uses a location of the client device 120A to retrieve a previously generated topographical mesh for the real-world environment. In embodiments where the topographical mesh management module 220 generates the mesh, the topographical mesh management module 220 uses scanning information captured from a scan of the real-world environment using one or more sensors managed by the sensor module 210. In embodiments where the topographical mesh management module 220 retrieves a previously generated topographical mesh, the topographical management module 220 identifies and retrieves the previously generated topographical mesh (e.g., from the local datastore 250) using a geographic position of the client device 120A (e.g., GPS coordinate), scanning information, or other information.

The topographical mesh management module 220 can locally store topographical meshes generated by the client device 120A, or otherwise obtained, in the local datastore 250. The client device 120A can use topographical meshes obtained by the topographical mesh management module 220 for relevant processes of the client device 120A. For example, the topographical mesh management module 220 may determine a topographical mesh for a real-world environment was previously locally stored based on a scan of the real-world environment or a geographic position of the client device 120A. In the same or different embodiments, the topographical mesh management module 220 can provide topographical meshes to the server 110 for storage. In additional same or different embodiments, the topographical mesh management module 220 can obtain topographical meshes or other information describing the real-world environment from the server 110, such as topographical meshes stored at the server 110 corresponding to a real-world environment where the client device 120A is located.

In some embodiments, the topographical mesh management module 220 coordinates collection of scanning information for the real-world environment using the client device 120A by the player associated with the client device 120A. For instance, the topographical mesh management module 220 may provide a user interface for display on the client device 120A which displays scan-related information (i.e., a scanning interface), such as images of the real-world environment captured sensors managed by the sensor module 210. The scanning interface may include one or more interactable objects (e.g., virtual buttons) configured to control a state of the scanning process, such as interactable objects which initiate scanning, pause scanning, end scanning (e.g., to generate a topographical mesh using the collected scan-related information). The scanning interface may further include various visualizations of scan related information, such as visualizations of a portion of the topographical mesh generated during the scanning (e.g., the geometry of the topographical mesh) or depth information. Furthermore, the scanning interface may guide the player through the scanning process, such as by displaying messages or visual indicators describing portions of the real-world environment to scan or how much of the real-world environment to scan. In some embodiments, multiple client devices 120 concurrently coordinate collection of related topographical meshes by multiple respective users. For instance, the server 110 may direct the multiple client devices to collect the topographical meshes. The topographical meshes collected by the multiple client devices 120 may be combined into a single topographical mesh, as described for embodiments of the topographical mesh management module 220 below. As such, the multiple client device 120 may generate respective topographical meshes to collectively map out a real-world environment.

In some cases, the scanning interface may display information to a player indicating a deficiency of the scanned information (e.g. captured image quality or depth information quality). For example, the client device 120A may be in real-world environment with deficient lighting conditions for scanning (e.g., an indoor space with minimal natural or artificial light, or an outdoor space in the evening or at night). In this case, the topographical mesh management module 220 may display information indicating the lighting conditions are deficient for scanning (e.g., leading to inaccurate scanning information for generating or otherwise obtaining a topographical mesh), or insufficient for scanning (e.g., not providing the topographical mesh management module 220 sufficient information to generate or otherwise obtain a topographical mesh

In some embodiments, the topographical mesh management module 220 generates a topographical mesh using one or more mesh generation techniques. In particular, the topographical mesh generation module 210 can use scanning information to perform the one or more mesh generation techniques. The scanning information can be obtained directly by the client device 120A (e.g., using sensors managed by the sensor module 210) or retrieved from another device or remote system (e.g., the server 110). The topographical mesh management module 220 can use various computer vision techniques to obtain the scanning information or generate the topographical mesh, such as geometric computer vision techniques or machine learning-based computer vision techniques. For instance, using computer vision techniques, the topographical mesh management module 220 may determine depth information describing how far away the object in the real-world environment corresponding to each pixel is from the camera. Furthermore, the topographical mesh management module 220 can process the scanning information using various mesh generation techniques, such as Delaunay triangulation, Ruppert's algorithm, advancing front algorithms, etc. In some embodiments, the topographical mesh management module 220 determines location information (e.g., GPS coordinates) for a real-world environment where the client device 120A is located. For instance, the topographical mesh management module 220 can determine the geographic position of the real-world environment based on a geographic position of the client device 120A.

In some embodiments, the topographical mesh generation process used by the topographical mesh management module 220 generates a topographical mesh by combining new scanning information (e.g., collected by the client device 120A) and previously collected scanning information (e.g., stored on the client device 120A). In further same or different embodiments, the topographical mesh management module 220 generates topographical meshes in real-time or near real-time. For example, the topographical mesh management module 220 may generate a topographical mesh corresponding to a portion of the real-world environment within milliseconds or seconds after the client device 120A captured or received scanning information for the real-world environment.

In embodiments, the topographical mesh management module 220 uses the location information describing the real-world environment to determine if a previously generated topographical mesh for the real-world environment is stored locally or on the server. For example, topographical meshes stored in the local datastore 250 or on the server 110 may be stored in association with geographic positions and other location-related metadata (e.g., a description of the location, such as an address or location name). In the same or different embodiments, the topographical mesh management module 220 uses the location information describing the real-world environment to retrieve other data associated with the real-world location, such as scanning information stored by the client device 120 or the server 110.

If the topographical mesh management module 220 requests topographical meshes from the server 110 based on location information, the server 110 may determine whether the client device 120A is authorized to access some or all of the stored topographical meshes associated with the location information. For instance, some topographical meshes stored by the server 110 representing public environments (e.g., parks, entertainment venues, etc.) may be publicly accessible to any of the client devices 120. Other topographical meshes stored on the server 110 may be accessible only to authorized client devices 120, such as topographical meshes representing private environments (e.g., a player's home) or designated as private by the client device 120A when providing the topographical mesh to the server 110. Public and private game locations are described in greater detail below with reference to FIG. 3.

The topographical mesh management module 220 may use retrieved or generated topographical meshes to determine the pose (location and orientation) of the client device 120A in the real-world environment by comparing data captured by one or more sensors (e.g., an image captured by a camera) to the topographical mesh. For example, the topographical mesh management module 220 may use any suitable localization technique to determine a pose of the client device from an image captured by a camera of the device. In this way, a precise (e.g., accurate to approximately 1 cm and 0.1 degrees) position and orientation of the client device may be determined.

In some embodiments, the topographical mesh management module 220 dynamically combines some or all of multiple topographical meshes for relevant processes of the client device 120A. In these embodiments, the topographical mesh management module 220 can combine topographical meshes obtained from one or more sources, such as generated by the client device 120A, retrieved from the local datastore 250, or retrieved from the server 110. For example, the topographical mesh management module 220 may generate a topographical mesh representing an indoor space where the client device 120A is located, such as a house, by retrieving one or more previously generated topographical meshes representing a first portion of the indoor space (e.g., the living room, the dining room, etc.) and generating a new topographical mesh for second portion of the indoor space to generate one or more other topographical meshes representing portions of the indoor space. Topographical meshes retrieved by the topographical mesh management module 220 (e.g., to combine) may be generated by the client device 120A or other client devices 120 concurrently or within a time interval.

The topographical mesh management module 220 may combine (e.g., stitch) the one or more retrieved or generated topographical meshes and provide the combined topographical meshes to other components of the client device 120A (e.g., the game module 240) to use for displaying AR content. The combined one or more topographical meshes can be entirely generated by the client device 120A or crowdsourced from multiple client devices 120, such as via the network 130. In some embodiments, the topographical mesh management module 220 generates or retrieves topographical meshes as the location of the client device 120A changes. For example, the topographical mesh management module 220 may retrieve or generate a topographical mesh representing a room of an indoor space after determining the client device 120A has entered the room. In the same or different embodiments, other components of the client device 120A combine topographical meshes received from the topographical mesh management module 220.

The custom view module 230 displays virtual (e.g., AR or VR) content from custom viewpoints using a topographical mesh or other 3D map (embodiments using topographical meshes are described below for clarity but it should be appreciated that the same approach may be applied with other type of 3D map). In some embodiments, the custom view module 230 simulates a custom view of the real-world environment by providing an AR interface for display by the client device 120A that includes a visualization of one or more topographical meshes. In particular, the custom view module 230 displays the visualizations of the topographical mesh in a three-dimensional space from a viewpoint of a virtual camera to simulate viewing the real-world environment from the one or more custom viewpoints via a physical camera (e.g., managed by the sensor module 210). The custom viewpoint may be a pose that is determined by applying a transformation to the actual pose of a physical camera of the client device determined using the topographical mesh of the real-world environment. In one embodiment, the transformation is a rotation from the pose of the physical camera without changing the position of the virtual camera relative to the physical camera (e.g., allowing the user to hold a phone comfortably with the camera at an angle between 35 and 65 degrees relative to the ground while seeing a view of the real-world environment as if they were pointing the camera of their device straight ahead, parallel to the ground). In other embodiments, the position or position and orientation of the virtual camera are changed relative to the pose of the physical camera of the client device.

The AR interface can include virtual objects in the three-dimensional space overlaid on the visualization of the one or more topographical meshes (i.e., AR objects). For instance, the AR interface can display AR objects in the simulated three-dimensional space to simulate the appearance of the AR object in the real-world environment represented by the one or more topographical meshes. For example, the AR objects may be displayed interacting with real-world objects represented by the one or more topographical mesh (e.g., a table, chair, floor, ceiling, wall, etc.). In some embodiments, the AR interface is associated with a parallel reality game hosted by the server 110, as described in detail below with reference to the game module 240 and FIG. 3. In this case, the AR objects displayed with the visualizations may be interactive game objects (e.g., game buttons, game items, etc.), game characters (e.g., a game character controllable by the player), game effects, or any other AR content of the parallel reality game.

In other embodiments, the custom view module 230 can display a custom view of an entirely virtual world (e.g., a visualization of a topographical mesh of a virtual environment that is mapped to the physical environment of the client device 120A) and the user can move the virtual camera around in the virtual environment by moving the physical camera of the client device in the real world.

In some embodiments, the AR interface provided by the custom view module 230 is configured to allow a player associated with the client device 120A to adjust the custom viewpoint of the AR interface (e.g., zoom in, zoom out, pan up, pan down, pan left, pan right, etc.). For instance, the AR interface can be configured to respond to certain inputs by the player (e.g., clicks, touches, swipes, etc.) or provide other interactable mechanisms that adjust the custom view. In the same or different embodiments, the custom view module 230 controls the custom view of the AR interface, such as selecting a particular custom viewpoint or restricting the custom viewpoints available to the player. For instance, a parallel-reality game or other application associated with the AR interface may be configured to use one or more viewpoints of the simulated real-world environment (e.g., an overhead viewpoint or a first-person viewpoint). In this case, the custom view module 230 may automatically adjust the AR interface to display one or more topographical meshes from a viewpoint corresponding to the parallel-reality game or other application.

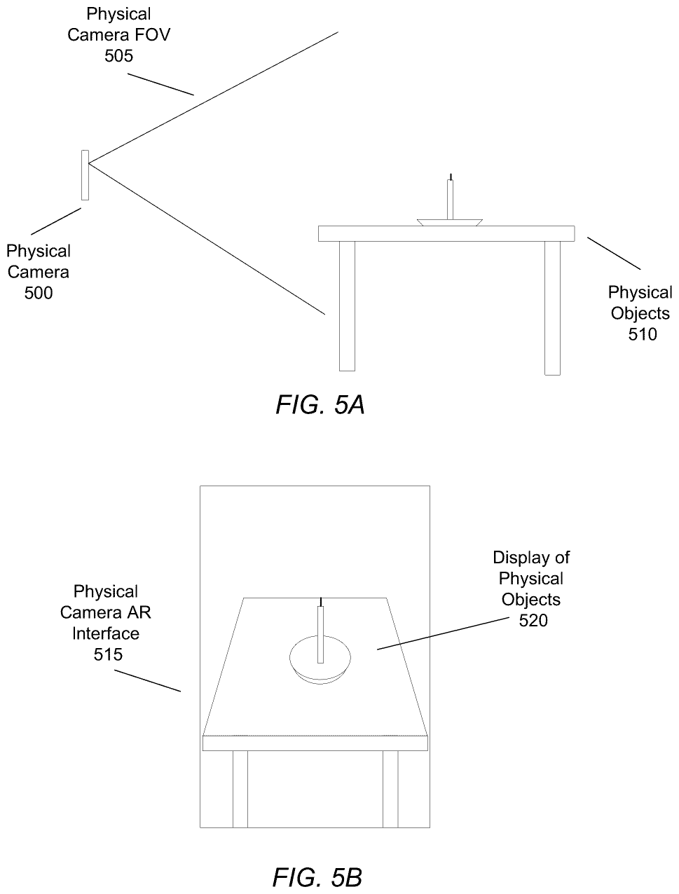

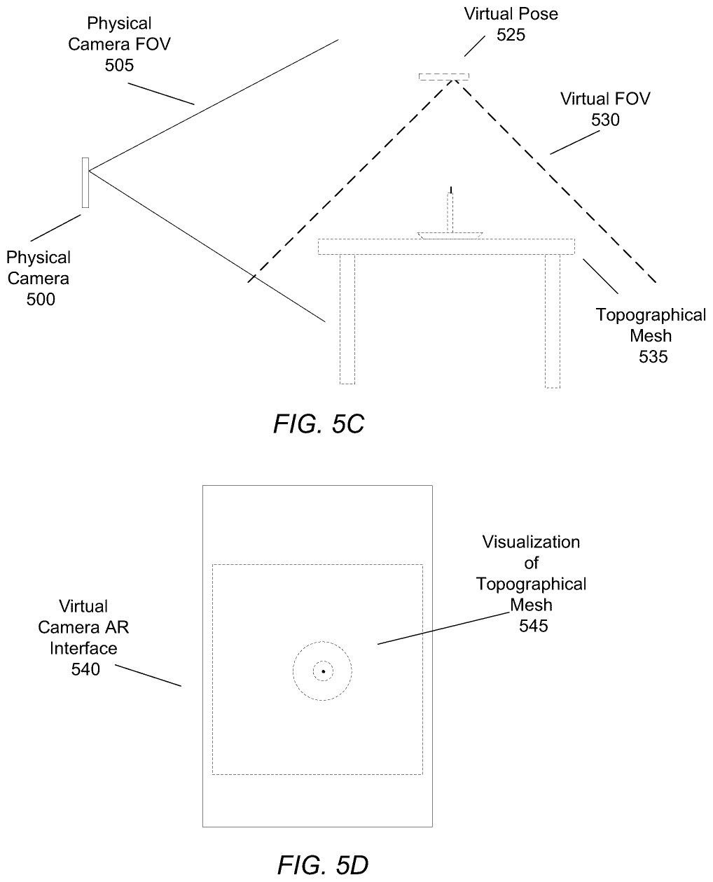

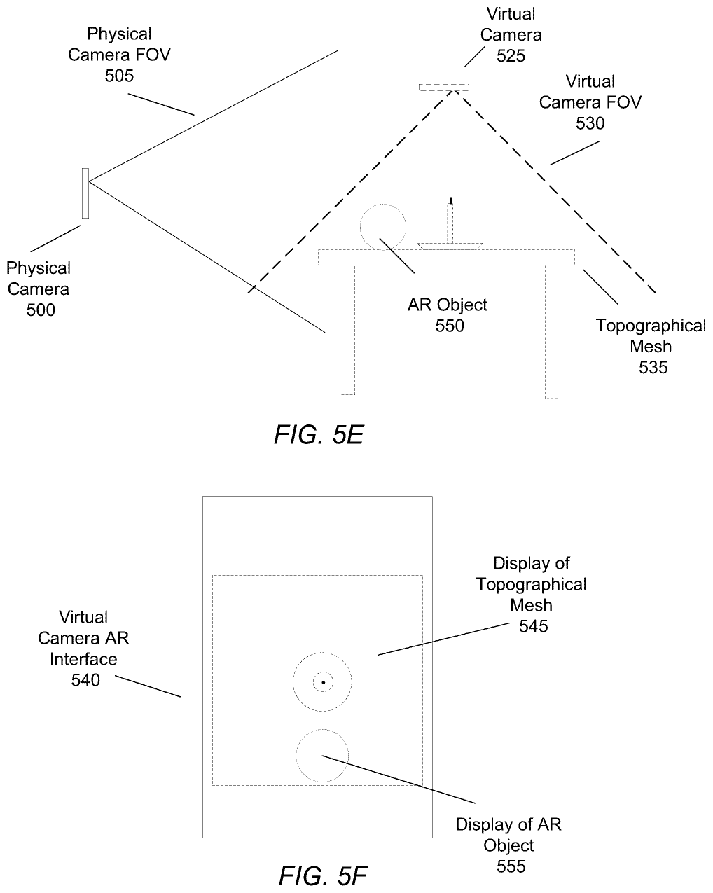

In some embodiments, the custom view module 230 provides an AR interface which transitions between displaying images of the real-world environment captured by a physical camera associated with the client device 120A and displaying a visualization of a topographical mesh representing the same real-world environment. For instance, the AR interface may transition back and forth from a physical camera AR interface displaying images captured by a physical camera to a virtual camera AR interface displaying a topographical mesh. The custom view module 230 may transition between the physical camera AR view and the virtual camera AR view based on input from a player associated with the client device 120A. As an example, the AR interface may be associated with a parallel-reality game where the player views AR game content from the viewpoint of a camera managed by the sensor module 210 in a physical camera AR view mode and views the same or different AR content from a custom viewpoint (e.g., using a viewpoint distinct from the viewpoint of the physical camera) in a virtual camera AR mode. In transitioning, the custom view module 230 can provide an animation from a view of a physical camera AR interface to a view of the virtual camera AR interface. The animation can include a view that travels along a continuous path from the view of the physical camera AR interface to the view of the virtual camera AR interface. A physical camera AR interface and a virtual camera AR interface are described in greater detail below with reference to FIGS. 5A-F.

The game module 240 operates a client-side game application for a parallel reality game hosted by the server 110. The game module 240 receives or obtains game data from the server 110. For example, the game module 240 may receive game data from the server 110 describing available game content based on the location of a client device 120 (e.g., game items), the geographic locations of devices associated with other players, or upcoming community events (e.g., competitive tournaments). In the same or different embodiments, the game module 240 communicates with the custom view module 230 to display custom views of AR game content associated with the parallel-reality game.

The local datastore 250 is one or more computer-readable media configured to store data used by the client device 120. In one embodiment, the local datastore 250 stores information describing topographical meshes that were retrieved or generated by the topographical mesh management module 220 or otherwise obtained or determined by the client device 120A. The local datastore 250 can additionally, or alternatively, store other information describing real-world environments, such as player location information tracked by the client device 120A (e.g., via GPS receiver), a local copy of the current state of the parallel reality game, or any other appropriate data. Although the local datastore 250 is shown as a single entity, the data may be split across multiple media. Furthermore, data may be stored elsewhere (e.g., in a distributed database) and accessed remotely via the network 130.

FIG. 3 illustrates one embodiment of the server 110 hosting a location-based parallel reality game. In the embodiment shown, the server 110 includes a universal game module 310, a universal topographical mesh module 320, a game datastore 330, and a universal topographical mesh datastore 340. In other embodiments, the server 110 includes different or additional elements. In addition, the functions may be distributed among the elements in a different manner than described.

The server 110 can be configured to receive requests for game data or information describing topographical meshes from one or more client devices 120 (for instance, via remote procedure calls (RPCs)) and to respond to those requests via the network 130. For instance, the server 110 can encode game data or information describing topographical meshes in one or more data files and provide the data files to a client device 120. In addition, the server 110 can be configured to receive game data (e.g., player location, player actions, player input, etc.) or information describing topographical meshes from one or more client devices 120 via the network 130. For instance, the client device 120 can be configured to periodically send player input, player location, and other updates to the server 110, which the server 110 uses to update game data in the game datastore 330 to reflect changed conditions for the game. The server 110 may also send game data or information describing topographical meshes to client devices 120. For example, the server 110 may send some or all of the geometric, texture, or color information corresponding to a topographical mesh. In some embodiments, the server 110 provides information which is used by the client devices 120 to generate a topographical mesh (e.g., as described above with reference to the topographical mesh management module 220.

The universal game module 310 hosts the location-based game for players and acts as the authoritative source for the current status of the location-based game. The universal game module 310 receives game data from client devices 120 (e.g., player input, player location, player actions, player status, landmark information, etc.) and incorporates the game data received into the overall location-based game for all players of the location-based game. With the game data, the universal game module 310 stores a total game state of the game that can be sent to a client device 120 to update the local games state in the game module 240. The universal game module 310 can also manage the delivery of game data to the client devices 120 over the network 130.

The universal topographical mesh module 320 can be a part of or separate from the universal game module 310. The universal topographical mesh module 320 is configured manage topographical meshes stored in the universal topographical mesh datastore 340. In some embodiments, the universal topographical mesh module 320 receives and stores topographical meshes generated by the client devices 120. The universal topographical mesh module 320 further provides topographical meshes to client devices 120. For instance, the universal topographical mesh module 320 may receive and store a topographical mesh module generated by the client device 120A and later provide the previously generated topographical mesh to a different client device 120B. As described above in reference to the topographical mesh management module 220, the universal topographical mesh module 320 may provide a topographical mesh to a client device 120 based on location information provided by the client device 120. Furthermore, the universal topographical mesh module 320 store private and public topographical meshes, where public topographical meshes are publicly accessible to client device 120 and private topographical meshes are accessible only to authorized client devices.

In some embodiments, the universal topographical mesh module 320 generates topographical meshes for real-world environments using scanning information or other information corresponding to the real-world environments. For instance, the universal topographical mesh module 320 can receive scanning data captured by one or more client devices 120 and use the received scanning information to generate the topographical meshes (e.g., using one of the mesh generation techniques described above with reference to the topographical mesh management module 220).

The game datastore 330 includes one or more machine-readable media configured to store game data used in the location-based game to be served or provided to client devices 120 over the network 130. In embodiments, the game data stored in the game datastore 330 can include: (1) data associated with the virtual world in the location-based game (e.g. imagery data used to render the virtual world on a display device, geographic coordinates of locations in the virtual world, etc.); (2) data associated with players of the location-based game, such as player profile or account data (e.g. player information, player experience level, player currency, player inventory, current player locations in the virtual world/real world, player energy level, player preferences, team information, etc.); (3) data associated with game objectives (e.g. data associated with current game objectives, status of game objectives, past game objectives, future game objectives, desired game objectives, etc.); (4) data associated virtual elements in the virtual world (e.g. positions of virtual elements, types of virtual elements, game objectives associated with virtual elements, corresponding actual world position information for virtual elements, behavior of virtual elements, relevance of virtual elements, etc.); (5) data associated with real world objects, landmarks, positions linked to virtual world elements (e.g. location of real world objects/landmarks, description of real world objects/landmarks, relevance of virtual elements linked to real world objects, etc.); (6) game status (e.g. current number of players, current status of game objectives, player leaderboard, etc.); (7) data associated with player actions/input (e.g. current player locations, past player locations, player moves, player input, player queries, player communications, etc.); (8) data associated with virtual experiences (e.g., locations of virtual experiences, players actions related to virtual experiences, virtual events such as raids, etc.); and (9) any other data used, related to, or obtained during implementation of the location-based game. The game data stored in the game datastore 330 can be populated either offline or in real time by system administrators or by data received from players, such as from one or more client devices 120 over the network 130.

The game datastore 330 may also store real-world data. The real-world data may include population density data describing the aggregate locations of individuals in the real world; player density data describing the aggregate locations of players in the real world; player actions associated with locations of cultural value or commercial value; player heat map data describing the distribution of game actions in a geographic area; point of interest data describing real-world locations that correspond to locations of virtual elements in the virtual world; terrain data describing the locations of various terrains and ecological conditions, such as large bodies of water, mountains, canyons, and more; map data providing the locations of roads, highways, and waterways; current and past locations of individual players; hazard data; weather data; event calendar data; activity data for players (e.g., distance travelled, minutes exercised, etc.); and other suitable data. The real-world data can be collected or obtained from any suitable source. For example, the game datastore 330 can be coupled to, include, or be part of a map database storing map information, such as one or more map databases accessed by a mapping service. As another example, the server 110 can be coupled to one or more external data sources or services that periodically provide population data, hazard data, weather data, event calendar data, or the like.

The universal topographical mesh datastore 340 is one or more computer-readable media configured to store information describing topographical meshes received by the universal topographical mesh module 320. The information stored by the universal topographical mesh store 340 may be retrieved or generated by the topographical mesh management module 220 or otherwise obtained or determined by the server 110. The information describing topographical meshes received by the universal topographical mesh datastore 340 can include geometric information, texture information, color information, location information, or other information corresponding to topographical meshes.

Other modules beyond the modules shown in FIG. 3 can be used with the server 110. Any number of modules can be programmed or otherwise configured to carry out the server-side functionality described herein. In addition, the various components on the server-side can be rearranged. Other configurations will be apparent in light of this disclosure and the present disclosure is not intended to be limited to any particular configuration.

Offsetting Virtual Pose from Corresponding Physical Pose

Online systems such as a game server 110 may maintain virtual models that represent the physical world. These virtual models represent structures and geographical features within the physical world through 3D structures like meshes (e.g., the topographical meshes stored in the universal topographical mesh datastore 340). A client device 120 can provide a virtual reality (VR) or augmented reality (AR) experience that includes displaying images rendered from the virtual model. The client device 120 or the game server 110 may determine a pose of the client device within the physical world and identify a corresponding pose within the virtual model that mimics the physical pose. For example, if a user is holding the client device at eye level and facing down a sidewalk of a street, the online system renders an image from a pose within the virtual model that is appears to be positioned at eye level and down a virtual sidewalk of a virtual street. However, this direct correspondence between a physical pose of a client device and the rendered virtual pose can require the user to hold the client device at uncomfortable or awkward positions for extended periods of time. For example, to be presented with an image rendered at an eye-level virtual pose, the user would generally have to hold the client device at eye level. These restrictions limit users' abilities to interact with the VR or AR experience for extended periods of time. In various embodiments, the client device 120 applies an offset to the virtual pose relative to the physical pose to enable the user to hold the client device in a more comfortable position and orientation. Although the client device 120 is generally described as applying the offset, in some embodiments, the client device 120 provides camera images (or information derived from camera images) to the game server 110, which determines the pose of the client device from the received data, applies the offset, and provides the resulting virtual pose back to the client device.

In one embodiment, the custom view module 230 obtains a physical pose of a client device 120. A physical pose is the position and orientation of the client device 120 within the physical world. The physical pose may be relative to some origin or reference point within the physical world. For example, the physical pose may be positioned using longitude, latitude, and altitude relative to the Earth's surface and may be oriented based on cardinal directions and a vector pointing towards the center of the Earth.

The data describing the physical pose of the client device 120 may include sensor data captured by a sensor on the client device (e.g., by the sensor module 210). For example, the client device 120 may include a camera, an accelerometer, a global navigation satellite system (GNSS) sensor, a gyroscope, or an inertial measurement unit (IMU) and may capture sensor data from the sensor to describe the client device's pose. In some embodiments, the data describing the physical pose of the client device 120 includes images or video that are then used to localize the client device against a 3D map (e.g., a topographical mesh) representing the physical environment of the client device. For example, a machine-learning model may be used to predict a physical pose of the client device based on the received data. In embodiments where the received data includes images or video captured by a camera, the online system may use visual inertial odometry or a visual positioning system to determine the physical pose of the client device. In embodiments where the online system uses a visual positioning system to determine the physical pose of the client device 120, the client device may include a wide-angle camera to capture additional areas of the physical world while the client device is positioned at a more comfortable position for the user. Transformations may be applied to portions of images captured by the wide angle camera to remove distortions so that the visual positioning system can still accurately identify the physical pose of the client device 120.

The custom view module 230 accesses a virtual model that is a virtual representation of the physical world or a virtual world that is mapped to the physical world. The virtual model may have 3D structures that correspond to structures within the physical world (e.g., buildings, plants, hills, bodies of water, landmarks). These virtual 3D structures are positioned and oriented within the virtual model like the position and orientation of their physical counterparts. In some embodiments, the virtual model includes additional augmentations to the 3D structures that cause rendered images of the virtual model to appear like augmented versions of the physical world. For example, the virtual model may include an augmentation that changes the apparent color or material of a building. These augmentations may be in accordance with some theme (e.g., fantasy or science fiction).

The custom view module 230 determines a virtual pose within the virtual model to use for rendering an image to display to the user. The virtual pose is offset from a typical direct correspondence from the physical pose within the physical pose. To determine the virtual pose to render, the custom view module 230 computes an offset to apply to the current physical pose. The offset is a transformation to apply to an initial virtual pose for the physical pose to determine a final virtual pose to use for rendering an image for the user. The offset may be applied to the orientation of the client device 120, the position of the client device, or both. The initial virtual pose is a pose that would directly correspond to the physical pose of the user's client device. For example, the initial virtual pose has a similar position and orientation relative to structures within the virtual model as the physical pose does to the corresponding structures within the physical world. The online system applies the offset to the initial virtual pose to compute the final virtual pose to render.

In one embodiment, the offset between the initial virtual pose and final virtual pose is fixed. For example, the offset is a constant translation and rotation of the virtual pose's position and orientation, respectively. In some embodiments, the offset includes an upwards translation of the virtual pose's location and a rotation of the virtual pose's orientation along a pitch axis (e.g., as determined from a gravity vector provided by a gravity sensor). Alternatively, the offset may be dynamically determined by the custom view module 230 based on the client device's 120 physical pose. For example, the custom view module 230 may apply a function that computes the final virtual pose based on an initial pose. This function may output a final virtual pose that is pointing straight upwards or downwards when the initial virtual pose is also pointing straight upwards or downwards, respectively. However, the function may adjust the rate at which the final virtual pose changes between those two poses from the rate at which the initial pose changes between those poses. For example, the function may have a slower rate of change of the final virtual pose while the initial pose is between straight upwards and some particular intermediate pose. Then, when the initial pose passes that intermediate pose, the function may have a faster rate of change for the final virtual pose until both poses meet at the straight-downwards pose. In some embodiments, the custom view module 230 uses a function whose first derivative is continuous at the intermediate pose to ensure that the rate of change of the final virtual pose does not change instantly at that intermediate pose (e.g., the function may be a sine or cosine wave function of the angle of the camera pose relative to the ground plane).

In some embodiments, the custom view module 230 allows the user to calibrate the offset that is used for adjusting the virtual pose. In cases where a fixed offset is used, the custom view module 230 may enable the user to set what the fixed offset should be by directing the user hold their client device 120 in a “comfortable” position for a target virtual pose for a set time period and calculating the offset as the difference between the target virtual pose and the average (e.g., mean) of the physical pose of the client device during the time period. For example, the custom view module 230 may instruct the user to hold their client device 120 in a position that is comfortable for rendering an eye-level, forward facing view and determines the offset such that when the user is holding the client device in the comfortable position in future, the client device displays an eye-level, forward facing view of the environment of the client device. In embodiments where the online system dynamically adjusts the offset, the custom view module 230 may set the initial virtual pose that corresponds to the physical pose at the “comfortable” position as the intermediate pose.

The custom view module 230 applies the determined offset to the initial virtual pose to determine the final virtual pose and generates an image to provide to a user by rendering an image of the virtual model based on the final virtual pose. In embodiments where the game server 110 determines the final virtual pose, the game server 110 may transmit a generated image to the client device for display to the user or transmit the final virtual pose to the client device to enable it to determine a view of the virtual to render. In some embodiments, the above-described process may be iterated to generate a video of the virtual model that uses camera poses that change as the user moves their client device 120.

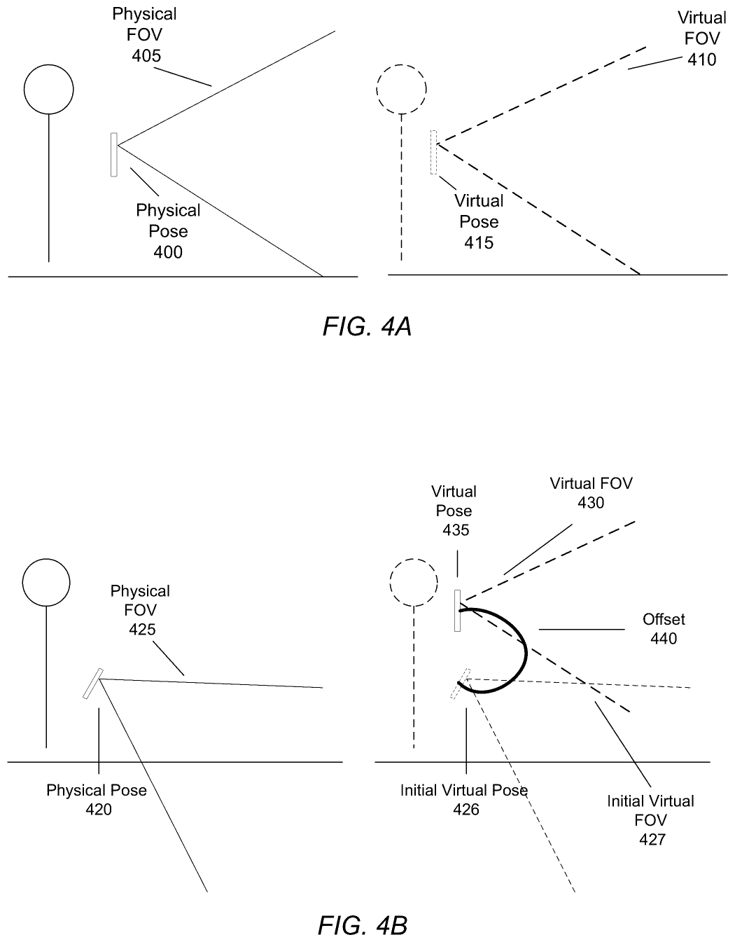

FIG. 4A illustrates an example physical pose 400 with a corresponding field of view (FOV) 405 and a virtual pose 415 with its corresponding FOV 410. The physical pose 400 is depicted in FIG. 4A to illustrate the position or orientation of the virtual pose 415 in a virtual three-dimensional space relative to the position or orientation of the physical pose 400 in the real-world environment. The physical FOV 405 is a field of view of the physical world at the physical pose 400. The virtual FOV 410 is a field of view of the virtual world and the virtual pose 415. FIG. 4A illustrates when the physical pose 400 directly corresponds to the virtual pose 415. As a result, the physical FOV 405 is parallel to the virtual FOV 410.

FIG. 4B illustrates an embodiment in which an offset is applied to a virtual pose to allow a user to hold their client device in a more comfortable physical position. In the embodiment shown, there is a physical pose 420 with a corresponding FOV 425, an initial virtual pose 426 with a corresponding initial virtual FOV 427, and a virtual pose 435 with a corresponding FOV 430, which is at an offset 440 relative to the initial virtual pose 426. In other words, FIG. 4B illustrates a scenario where the physical pose 420 does not directly correspond to the virtual pose 435. Instead, the initial virtual pose 426 directly corresponds to the physical pose 420 and the online system applies the offset 440 to the initial virtual pose 426 to determine the final virtual pose 435. Thus, the final virtual pose 435 is also offset from the physical pose 420.

FIGS. 5A-F illustrate embodiments of a physical camera AR interface 515 and a virtual camera AR interface 540 displaying views of the same real-world environment. The physical camera 515 and virtual camera 540 AR interfaces depicted in FIGS. 5A-F are provided for the purposes of illustration, and other embodiments include different AR interfaces.

FIG. 5A illustrates a real-world environment including physical objects 510 captured by a physical camera 500 with a field of view (FOV) 505. In the example shown, the physical objects 510 include a table, a plate, and a candle. The physical objects 510 are included for the purposes of illustration, and any other physical object which can be represented using a topographical mesh or other 3D map is possible. The images of the physical objects 510 captured by the physical camera 500 can be used by a client device (e.g., the client device 120A) for a variety of purposes, including obtaining a topographical mesh, localization, or providing a physical camera AR interface 515 as depicted in FIG. 5F.

FIG. 5B illustrates an embodiment of the physical camera AR interface 515 displayed by a client device (e.g., the client device 120A). In the embodiment shown, the physical AR interface 515 includes a display 520 of the physical objects 510. The display of the physical objects 520 is from the perspective of the physical camera FOV 505. Although AR content is not displayed in the physical camera AR interface 515 as depicted, the physical camera AR interface 515 can include AR objects, such as AR objects positioned on top of one of the physical objects 510. Furthermore, as the physical camera 500 changes position in the real world (e.g., moved by a player associated with the client device), the client device can display AR objects in the physical camera AR interface 515 to appear in the same position in the real-world environment as the physical camera 500 changes position.

FIG. 5C illustrates an embodiment in which a visualization of a topographical mesh 535 is displayed. The visualization represents the same real-world environment including the physical objects 510 depicted in FIG. 5A. The topographical mesh 535 includes information about the geometry, color, and other properties of the real-world environment, including the physical objects 510, which may enable the visualization to be a photo-realistic or close to photo-realistic representation of the real-world environment. The visualization depicts the environment from the perspective of a virtual camera 525 with a virtual camera FOV 530. The physical camera 500 is depicted in FIGS. 5C-5F to illustrate the position of the virtual camera 525 in a virtual three-dimensional space including the visualization generated from the topographical mesh 535 relative to the position of the physical camera 500 in the real-world environment. Specifically, the virtual camera 525 has a pose offset relative to the physical camera 500. Thus, in some embodiments, the user may rotate the camera and which portion of topographical mesh 535 the virtual camera 525 is located directly above by moving their client device.

The virtual camera 525, virtual camera FOV 530, and visualization of the topographical mesh 535 are depicted using dashed lines to distinguish them from the physical camera 500, physical camera FOV 505, and physical objects 510, respectively. As such, the dashes for the virtual camera 525, virtual camera FOV 530, and visualization of the topographical mesh 535 in FIGS. 5C-5F are not indicative of their appearances in the three-dimensional space. As depicted, the virtual camera 525 is positioned directly above the topographical mesh 535 and the virtual camera FOV 530 is directed straight down at the topographical mesh. However, it should be appreciated that different pose offsets may be defined to provide a wide range of virtual camera angles and orientations, all of which may be manipulated by the user by moving their client device around the physical environment. Furthermore, the virtual camera FOV 530 can be adjusted to capture more or less of the topographical mesh 535.

FIG. 5D illustrates an embodiment of the virtual camera AR interface 540 displayed by the client device (e.g., the client device 120A). In the embodiment shown, the virtual camera AR interface 540 includes a visualization 545 of the topographical mesh 535. The visualization 545 of the topographical mesh 535 is from the perspective of the virtual camera FOV 530. In some embodiments, the virtual camera AR interface 540 includes interactive mechanisms to allow a player associated with the client device to adjust the position of the virtual camera 525 or the virtual camera FOV 530 within the three-dimensional space including the topographical mesh 535, such as by adjusting the pose offset setting the relationship between the pose of the physical camera 500 and the virtual camera 525.

FIG. 5E illustrates an embodiment of AR content within the three-dimensional space including the topographical mesh 535 depicted in FIG. 5C. In the embodiment shown, an AR object 550 is positioned on top of the topographical mesh 535. As depicted, topographical mesh 535 provides a representation of the physical table, a physical candle, and an AR sphere, positioned to appear to be on top of the table. The depiction of the AR object 550 as a sphere is for the purpose of illustration only, and the AR object 550 can be a virtual object with any shape, texture, color, or other visual attributes. The AR object 550 may be a static or dynamic AR object. For example, the AR object may be an AR character in a parallel-reality game that moves around the AR environment interacting with other AR or physical objects.

The AR object 550 is depicted using fine dashed lines to distinguish it from the dashed lines representing the topographical mesh 535. As such, the fine dashes of the AR object 550 in FIGS. 5E-F are not indicative of the appearance of the AR object 550 in the three-dimensional space. The AR object 550 can additionally be displayed in the physical camera AR interface 515, such as overlaid on top of the images of the physical object 510. The AR object 550 may be a static AR object (e.g., in a fixed position) or dynamic AR object (moving around the three-dimensional space including the topographical mesh 535). Although only a single AR object 550 is depicted in FIGS. 5E-F, the three-dimensional space can include any number of AR objects.

FIG. 5F illustrates an embodiment of the virtual camera AR interface 540 that includes the AR object 550 displayed by the client device. In the embodiment shown, the AR interface 540 depicts the topological mesh 545 and AR object 555 from the perspective of the virtual camera 525. In this case, the AR interface depicts the table, candle, and sphere viewed from directly above. However, the virtual camera 525 may be positioned elsewhere in the three-dimensional space (e.g., at the direction of a user via input using a client device 120 to change the offset or by changing the pose of the client device) to view the topological mesh 545 and AR object 555 from other perspectives. Furthermore, although only a single AR object 550 is depicted in FIGS. 5E-F, the three-dimensional space including the topographical mesh 535 can include additional AR objects which can further be displayed by the virtual camera AR interface 540.

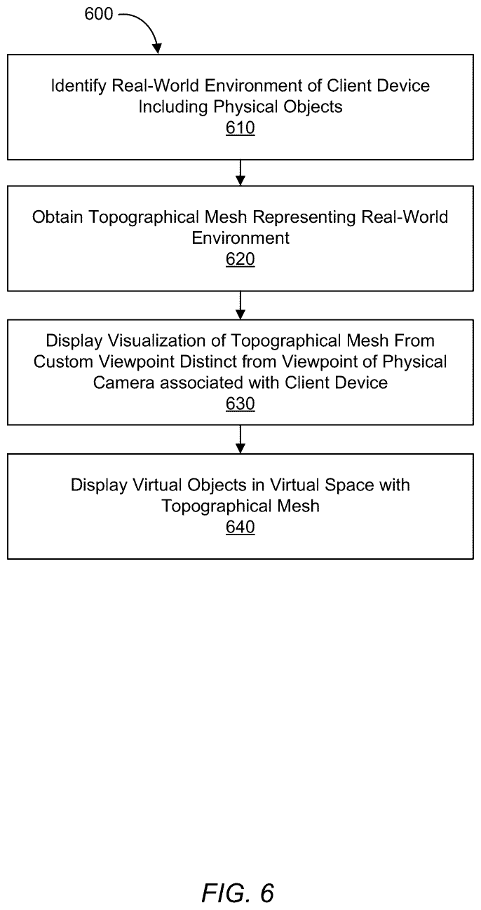

FIG. 6 is a flowchart illustrating an embodiment of a method 600 for providing virtual content on a client device from a custom viewpoint. In the embodiment shown, the steps of FIG. 6 are illustrated from the perspective a client device 120 performing the method 600, such as the client device 120A depicted in FIG. 2. However, some or all of the steps may be performed by other entities or components. In addition, some embodiments may perform different steps or perform some of the steps in a different order or in parallel.

In the embodiment shown in FIG. 6, the method 600 begins with the client device 120 identifying 610 a real-world environment of the client device and including one or more physical objects. For example, the client device 120 can identify a geographic position of the client device, such as based on a GPS receiver of the client device. As another example, the client device 120 can scan the real-world environment (e.g., using a camera associated with the client device) to collect images of the real-world environment or other sensor data and compare it to previously stored sensor data to determine the location of the device.

The client device 120 obtains 620 a topographical mesh (or other 3D map) representing the real-world environment (or a virtual environment mapped to the real-world environment). In particular, the topographical mesh includes geometry and colors corresponding to the one or more physical objects. For instance, the client device 120 can use images of the real-world environment or other sensor data to generate a topographical mesh. Alternatively, or additionally, the client device can retrieve a previously generated topographical mesh from local storage (e.g., the local datastore 250) or from remote storage (e.g., the universal topographical mesh datastore 340).

The client device 120 displays 630 a visualization of the topographical mesh from a custom viewpoint which is distinct from the viewpoint of a camera associated with the client device (e.g., a camera used capture images of the real-world environment). For example, the client device 120 can display a three-dimensional space including the topographical mesh from the perspective of a virtual camera that has a pose offset relative to the pose of a physical camera of the client device that is used for localization of the client device, as depicted in FIG. 4B. The client device 120 may further display 640 one or more virtual objects in a virtual space with the topographical mesh. For example, the client device 120 can display virtual objects associated with a parallel-reality game in a three-dimensional virtual space with the topographical mesh, as depicted in FIGS. 5E-F.

### Example Computer System

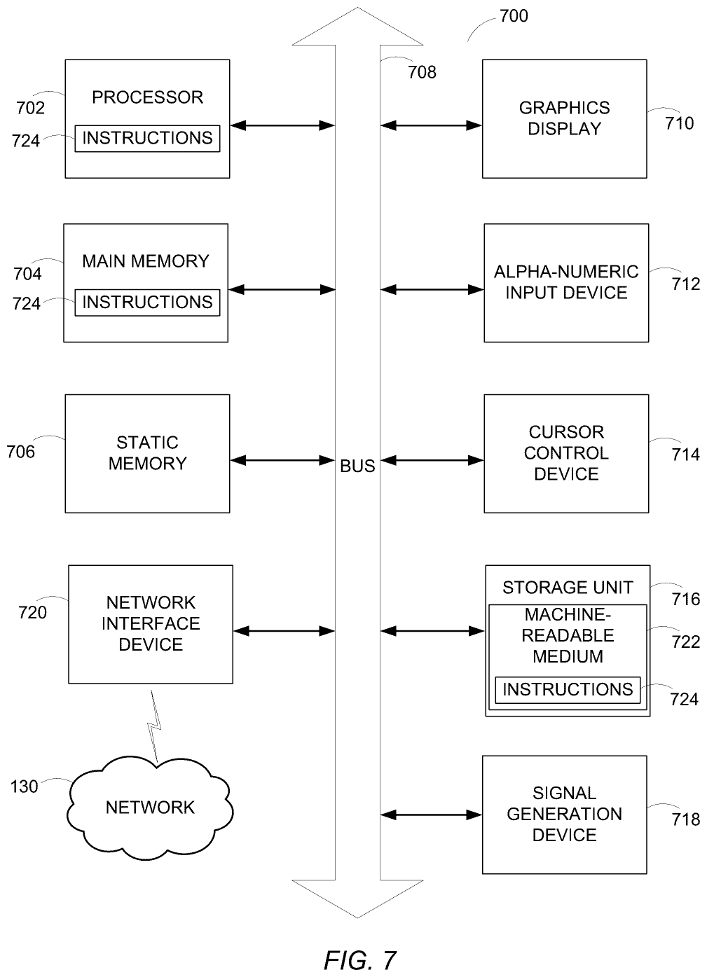

FIG. 7 is a block diagram illustrating an example computer suitable for use in the networked computing environment of FIG. 1, according to one embodiment. Specifically, FIG. 7 shows a diagrammatic representation of a machine in the example form of a computer system 700. The computer system 700 can be used to execute instructions 724 (e.g., program code or software) for causing the machine to perform any one or more of the methodologies (or processes) described herein, including those associated, and described, with the components (or modules) of a server 110 or client device 120.

The machine may be a server computer, a client computer, a personal computer (PC), a tablet PC, a set-top box (STB), a smartphone, a network router, switch or bridge, a cell phone tower, or any machine capable of executing instructions 724 (sequential or otherwise) that specify actions to be taken by that machine. Further, while only a single machine is shown, the term “machine” shall also be taken to include any collection of machines that individually or jointly execute instructions 724 to perform any of the disclosed methods.

The example computer system 700 includes one or more processing units (generally one or more processors 702). A processor 702 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. Any reference to a processor 702 may refer to a single processor or multiple processors. The computer system 700 also includes a main memory 704. The computer system may include a storage unit 716. The processor 702, memory 704, and storage unit 716 communicate via a bus 708.

In addition, the computer system 700 can include a static memory 706, a display driver 710 (e.g., to drive a plasma display panel (PDP), a liquid crystal display (LCD), or a projector). The computer system 700 may also include alphanumeric input device 712 (e.g., a keyboard), a cursor control device 714 (e.g., a mouse, a trackball, a joystick, a motion sensor, or other pointing instrument), a signal generation device 718 (e.g., a speaker), and a network interface device 720, which also are configured to communicate via the bus 708.

The storage unit 716 includes a machine-readable medium 722 which may store instructions 724 (e.g., software) for performing any of the methods or functions described above. The instructions 724 may also reside, completely or partially, within the main memory 704 or within the processor 702 (e.g., within a processor's cache memory) during execution by the computer system 700. The main memory 704 and the processor 702 also constitute machine-readable media. The instructions 724 may be transmitted or received over a network 130 via the network interface device 720.

While the machine-readable medium 722 is shown in an example embodiment to be a single medium, the term “machine-readable medium” should be taken to include a single medium or multiple media (e.g., a centralized or distributed database, or associated caches and servers) able to store the instructions 724. The term “machine-readable medium” shall also be taken to include any medium that is capable of storing instructions 724 for execution by the machine and that cause the machine to perform any one or more of the methods or functions disclosed herein. The term “machine-readable medium” includes, but is not limited to, data repositories in the form of solid-state memories, optical media, and magnetic media.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the element or component is present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs that may be used to employ the described techniques and approaches. Thus, while particular embodiments and applications have been illustrated and described, it is to be understood that the described subject matter is not limited to the precise construction and components disclosed. The scope of protection should be limited only by the following claims.

What is claimed is:

1. A computer-implemented method of determining a virtual pose for view of content, the computer-implemented method comprising:
identifying a real-world environment of a client device;
obtaining a 3D map corresponding to the real-world environment;
obtaining a physical pose of a camera of the client device;
determining the virtual pose by applying an offset to the physical pose; and
causing display of a view generated from the 3D map using the virtual pose.

2. The computer-implemented method of claim 1, wherein obtaining the 3D map comprises generating the 3D map based on images captured by the camera of the client device.

3. The computer-implemented method of claim 1, wherein obtaining the physical pose of the camera comprises determining the physical pose of the camera by comparing an image captured by the camera of the client device to the 3D map.

4. The computer-implemented method of claim 1, wherein the 3D map is a topographical mesh of the real-world environment.

5. The computer-implemented method of claim 1, wherein the offset comprises at least one of a predetermined rotation or a predetermined translation.

6. The computer-implemented method of claim 1, wherein the offset is determined by a calibration process that comprises:
directing a user to position the client device is a desired position;
collecting sensor data while the client device is in the desired position; and
calculating at least one of a rotation or translation of the offset that converts the physical pose while the client device is in the desired position to a desired virtual pose.

7. The computer-implemented method of claim 1, wherein the desired virtual pose is equivalent to the camera being at eye level of the user pointing along an axis parallel to a ground plane.

8. The computer-implemented method of claim 1, wherein the offset is a function of an angle of the physical pose relative to a ground plane.

9. The computer-implemented method of claim 8, wherein the function is a function whose first derivative is continuous.

10. The computer-implemented method of claim 1, wherein the view generated from the 3D map includes a virtual item.

11. A non-transitory computer-readable medium comprising instructions for determining a virtual pose for view of content, the instructions, when executed by a computing device, causing the computing device to perform operations including:
identifying a real-world environment of a client device;
obtaining a 3D map corresponding to the real-world environment;
obtaining a physical pose of a camera of the client device;
determining the virtual pose by applying an offset to the physical pose; and
causing display of a view generated from the 3D map using the virtual pose.

12. The non-transitory computer-readable medium of claim 11, wherein obtaining the 3D map comprises generating the 3D map based on images captured by the camera of the client device.

13. The non-transitory computer-readable medium of claim 11, wherein obtaining the physical pose of the camera comprises determining the physical pose of the camera by comparing an image captured by the camera of the client device to the 3D map.

14. The non-transitory computer-readable medium of claim 11, wherein the 3D map is a topographical mesh of the real-world environment.

15. The non-transitory computer-readable medium of claim 11, wherein the offset comprises at least one of a predetermined rotation or a predetermined translation.

16. The non-transitory computer-readable medium of claim 11, wherein the offset is determined by a calibration process that comprises:
directing a user to position the client device is a desired position;
collecting sensor data while the client device is in the desired position; and
calculating at least one of a rotation or translation of the offset that converts the physical pose while the client device is in the desired position to a desired virtual pose.

17. The non-transitory computer-readable medium of claim 11, wherein the desired virtual pose is equivalent to the camera being at eye level of the user pointing along an axis parallel to a ground plane.

18. The non-transitory computer-readable medium of claim 11, wherein the offset is a function of an angle of the physical pose relative to a ground plane.

19. The non-transitory computer-readable medium of claim 18, wherein the function is a function whose first derivative is continuous.

20. The non-transitory computer-readable medium of claim 11, wherein the view generated from the 3D map includes a virtual item.
